(19) United States
(12) Patent Application Publication
(10) Pub. No.: US 2023/0288682 A1
(43) Pub. Date: Sep. 14, 2023

(54) ZOOM LENS MODULE WITH SIMPLIFIED STRUCTURE, CAMERA MODULE, AND ELECTRONIC DEVICE HAVING THE SAME

(71) Applicant: TRIPLE WIN TECHNOLOGY(SHENZHEN) CO.LTD., Shenzhen (CN)

(72) Inventors: SHENG-JIE DING, Shenzhen (CN); JIAN-CHAO SONG, Shenzhen (CN); JING-WEI LI, Shenzhen (CN); DING-NAN HUANG, New Taipei (TW); SHIN-WEN CHEN, New Taipei (TW)

(21) Appl. No.: 17/879,032

(22) Filed: Aug. 2, 2022

(30) Foreign Application Priority Data
Mar. 9, 2022 (CN) 202210224847.2

(51) Int. Cl. G02B 15/14; G02B 7/09; G03B 3/10

(52) U.S. Cl. CPC G02B 15/143; G02B 7/09; G03B 3/10

(57) ABSTRACT

A simplified zoom lens module includes first to third lens units, first and second driving assemblies, and a housing. The lens units are arranged along an optical axis. The first driving assembly moves the second lens unit back and forth relative to the first lens unit, the second driving assembly moves the third lens unit back and forth relative to the second lens unit. The first driving assembly includes a first magnet which interacts with a second magnet, one being a permanent magnet, the other being an electromagnet. The first magnet is fixed inside the housing, the second magnet is fixed on the second lens unit. The first and second magnets are attracted to or repelled from each other by voltage and current fed to the electromagnet, thereby moving the lens and changing the focus of the lens module. A module and image-capturing device are also disclosed.

### FIELD

The subject matter herein generally relates to optical imaging, and more particularly, to a zoom lens module with simplified structure and reduced cost, and an imaging apparatus having the same.

### BACKGROUND

Electronic devices, such as smart phones, have zoomable lenses, that is, the focal length can be changed. Although the zoom lens is somewhat useful, its structure may be complicated. Thus, a zoom lens with a simple structure is still needed.

### BRIEF DESCRIPTION OF THE DRAWINGS

Many aspects of the disclosure can be better understood with reference to the following drawings. The components are not necessarily drawn to scale, the emphasis instead being placed upon clearly illustrating the principles of the disclosure.

FIG. 1 is an exploded view of a zoom lens module according to an embodiment of the present disclosure.

FIG. 2 is a cross-sectional view of the zoom lens module of FIG. 1.

FIG. 3 is a diagrammatic view of a first driving assembly of the zoom lens module of FIG. 1.

FIG. 4 is a diagrammatic view of a second lens unit and a first magnet connected thereto of the zoom lens module of FIG. 1.

FIG. 5 is a diagrammatic view of a prism of the zoom lens module of FIG. 1.

FIG. 6 is a diagrammatic view of a camera module according to an embodiment of the present disclosure.

FIG. 7 is a diagrammatic view of an electronic device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

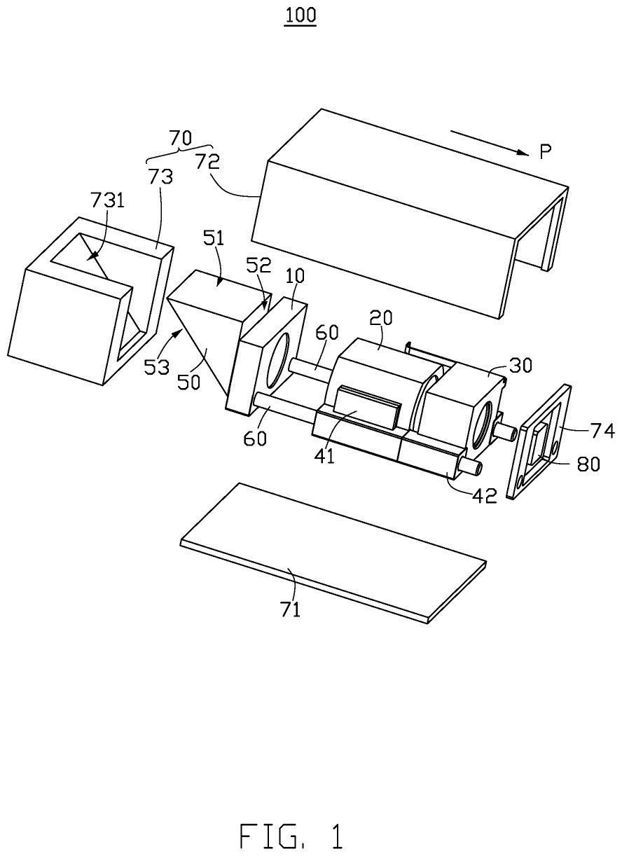

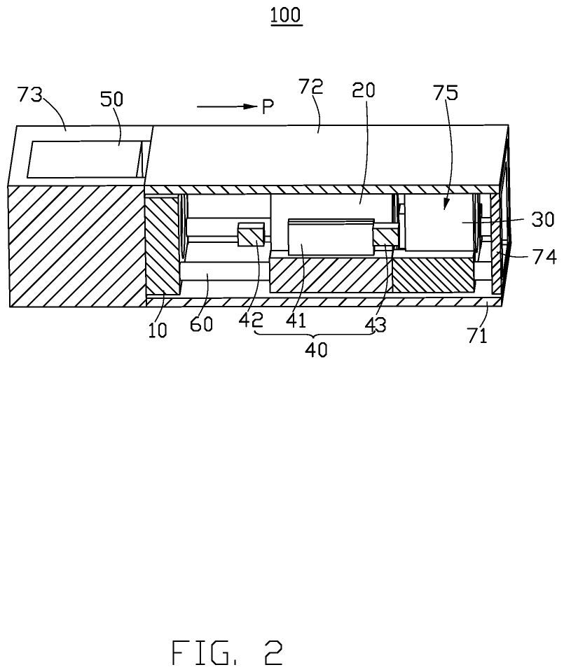

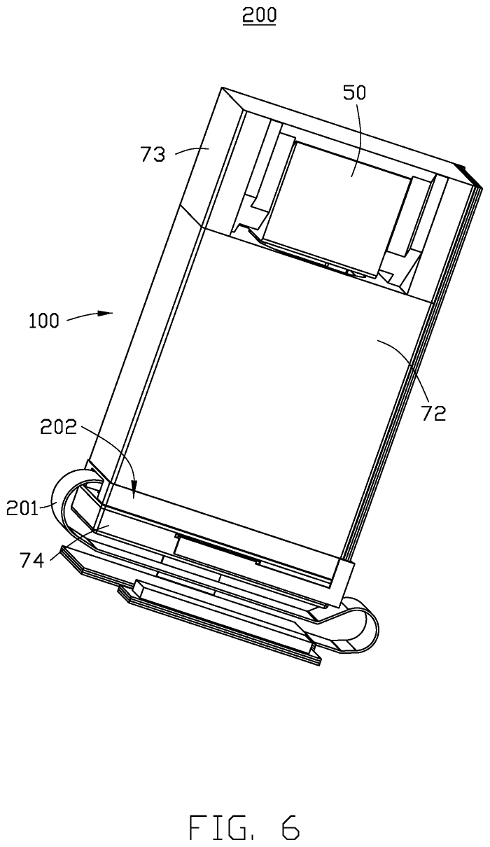

Referring to FIGS. 1 and 2, an embodiment of a zoom lens module 100 is provided. The zoom lens module 100 includes a first lens unit 10, a second lens unit 20, a third lens unit 30, a first driving assembly 40, a second driving assembly 80, and a housing 70. The first lens unit 10, the second lens unit 20, and the third lens unit 30 are arranged along an optical axis P. Light can travel through the first lens unit 10, the second lens unit 20, and the third lens unit 30, and then form an image on a sensor 202 (referring to FIG. 6). The first driving assembly 40 drives the second lens unit 20 to move back and forth relative to the first lens unit 10. The second driving assembly 80 drives the third lens unit 30 to move back and forth relative to the second lens unit 20. The first lens unit 10, the second lens unit 20, the third lens unit 30, the first driving assembly 40, and the second driving assembly 80 are disposed within the housing 70. In this embodiment, the second driving assembly 80 is a voice coil motor.

Referring to FIGS. 1, 2, and 3, the first driving assembly 40 includes a first magnet 41 and a second magnet 42 facing the first magnet 41. The first magnet 41 is fixed inside the housing 70 and disposed between the first lens unit 10 and the second unit 20. The second magnet 42 is fixed on the second lens unit 20. The first magnet 41 includes a first end portion 411 and a second end portion 412 facing the first end portion 411. The first end portion 411 can be polarized as north or south, the second end portion 412 will be the opposite polarity. The second magnet 42 includes a third end portion 421 and a fourth end portion 422 facing the third end portion 423. The third end portion 421 can be polarized as north or south, fourth end portion 422 will be the opposite polarity. The first end portion 411 faces the third end portion 421.

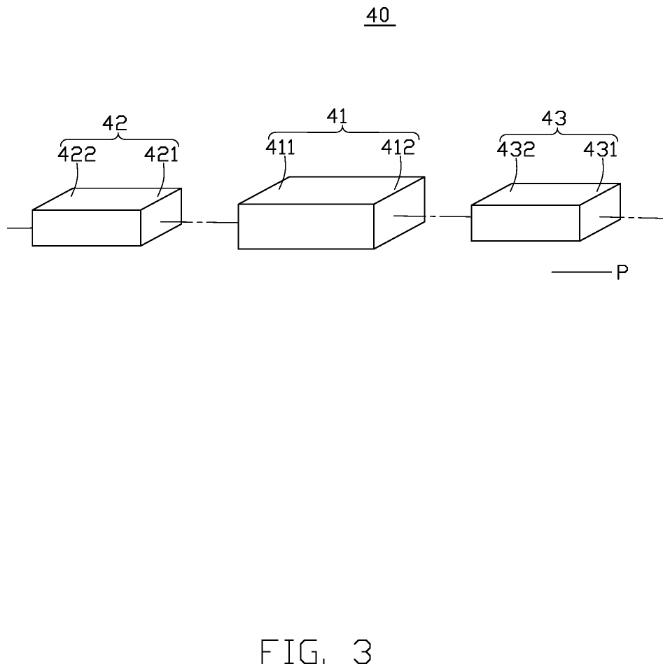

Referring to FIGS. 2 and 3, when the first end portion 411 is north pole and the third end portion 421 is south pole or when the first end portion 411 is south pole and the third end portion 421 is north pole, a magnetic attraction force between the first magnet 41 and the second magnet 42 drives the first magnet 41 to move towards the second magnet 42. When the first end portion 411 and the third end portion 421 are both north poles or when the first end portion 411 and the third end portion 421 are both south poles, a magnetic repelling force between the first magnet 41 and the second magnet 42 drives the first magnet 41 to move away from the second magnet 42. Thus, the first magnet 41 can move towards or away from the second magnet 42.

Referring to FIGS. 2 and 3, in some embodiments, the first magnet 41 is a permanent magnet, and the second magnet 42 is an electromagnet. Thus, each of the first end portion 411 and the second end portion 412 of the first magnet 41 has a fixed magnetic pole. Each of the third end portion 421 and the fourth end portion 422 has a non-fixed magnetic pole. Thus, when a direction of electric current supplied to the second magnet 42 is changed, the second magnet 42 will be moved along different directions. In other embodiments, the first magnet 41 is an electromagnet, and the second magnet 42 is a permanent magnet.

Referring to FIGS. 2 and 3, in some embodiments, the first driving assembly 40 further includes a third magnet 43. The third magnet 43 is fixed inside the housing 70 and disposed between the second lens unit 20 and the third unit 30. The third magnet 43 includes a fifth end portion 431 and a sixth end portion 432 facing the fifth end portion 431. The fifth end portion 431 faces the second end portion 412. The fifth end portion 431 can be polarized as north or south, and the sixth end portion 432 will be the opposite polarity. The fifth end portion 432 can attract or repel the second end portion 412. Thus, the third magnet 43 can attract or repel the first magnet 41. The third magnet 43 and the second magnet 42 can both interact with the first magnet 41 to promote a movement of the second lens unit 20. In some embodiments, the third magnet 43 is either a permanent magnet or an electromagnet.

In the present disclosure, the movements of the second lens unit 20 along different directions allows the zoom lens module 100 to have different ranges of movement and thus focus. In detail, when the second lens unit 20 moves towards the first lens unit 10, the zoom lens module 100 has a high range mode. When the second lens unit 20 moves away from the first lens unit 10, the zoom lens module 100 has a low range mode. The zoom lens module 100 has a simple structure and low cost.

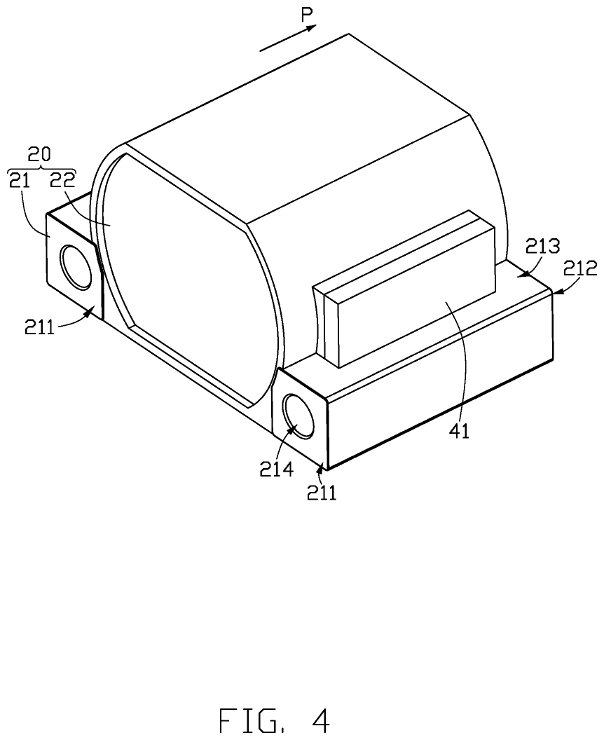

Referring to FIG. 4, the second lens unit 20 includes a guide portion 21 and a lens portion 22. The guide portion 21 is arranged on a surface of the lens portion 22. The guide portion 21 includes a first end surface 211, a second end surface 212, and a connecting surface 213. The first end surface 211 and the second end surface 212 are spaced from each other along the optical axis P. The connecting surface 213 is connected between the first end surface 211 and the second end surface 212. The first magnet 41 is disposed on the connecting surface 213. The second magnet 42 is disposed above the connecting surface 213 and faces the first magnet 41. In other embodiments, the first magnet 41 can be disposed on the lens portion 22.

Referring to FIGS. 1 and 3, the guide portion 21 defines a through hole 214 that extends along the optical axis P, and the through hole 214 penetrates the first end surface 211 and the second end surface 212. The zoom lens module 100 further includes guide rod 60 that can move through the through hole 214. The two ends of the guide rod 60 are fixed inside housing 70, so that the second lens unit 20 can be guided to move along the optical axis P.

In this embodiment, the second driving assembly 80 can be a VCM (Voice Coil Motor). The second driving assembly 80 is disposed on a surface of the third lens unit away from the second lens unit 20.

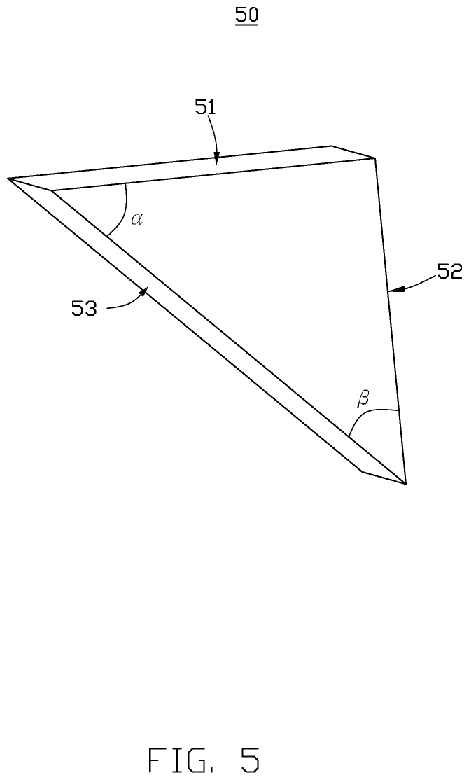

Referring to FIGS. 1 and 5, in this embodiment, the zoom lens module 100 further includes a prism 50. The prism 50 is disposed on a side of the first lens unit 10 away from the second lens unit 20. The prim 50 includes a first optical surface 51, a second optical surface 52, and a third optical surface 53. The first optical surface 51, the second optical surface 52 and the third optical surface 53 connected to form a triangular structure. The first optical surface 51 faces the outside scene to be imaged, and the second optical surface 52 faces the first lens unit 10. The light from the scene travels into the prism 50 through the first optical surface 51, is then reflected by the third optical surface 53, and travels out from the prism 50 through the second optical surface 52. Thus, the prism 50 changes direction of the light before the light enters the first lens unit 10. In other embodiments, the prism 50 can be another optical reflector, such as a reflecting mirror, the optical reflector is arranged on a side of the first lens unit 10 away from the second lens unit 20. The optical reflector is used for changing the direction of the light.

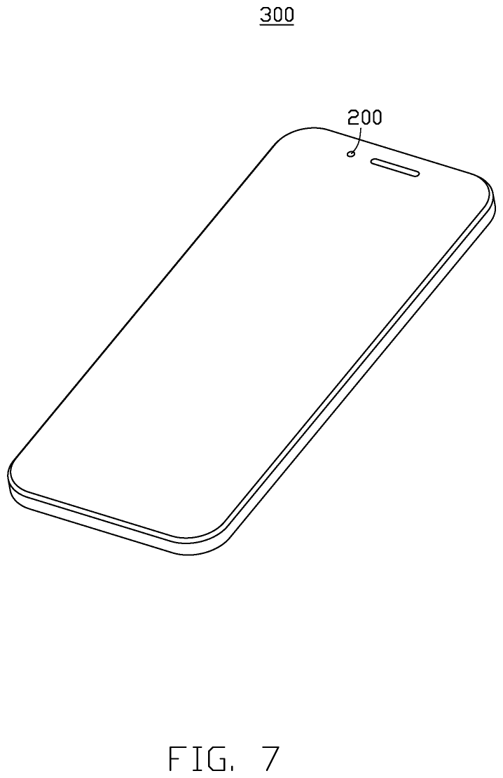

Referring FIG. 5, in this embodiment, the first optical surface 51 is perpendicular to the second optical surface 52. An included angle α is defined between the third optical surface 53 and the first optical surface 51 is 45 degrees. An included angle R is defined between the third optical surface 53 and the second optical surface 52 is 45 degrees. Thus, a 90-degree change in the direction of the light is affected by the prism 50, so the zoom lens module 100 can be fitted lengthways in an electronic device 300 (referring to FIG. 7).

Referring FIGS. 1 and 2, in this embodiment, the housing 70 includes a first portion 71, a second portion 72, a third portion 73, and a fourth portion 74. The first portion 71 faces the second portion 72, the third portion 73 faces the fourth portion 74. The first portion 71, the second portion 72, the third portion 73, and the fourth portion 74 are connected together to form a receiving space 75. The first lens unit 10, the second lens unit 20, the third lens unit 30, the first driving assembly 40, the second driving assembly 80, the prism 50, and the guide rod 60 are arranged inside the receiving space 75. The third portion 73 defines an opening 731 that connects to the receiving space 75. The first optical surface 51 is exposed from the opening 731. The second magnet 42 is fixed on the second portion 72.

Referring to FIG. 6, an embodiment of a camera module 200 is provided. The camera module 200 includes the above-mentioned lens module 100. The camera module 200 further includes a circuit board 201 and a sensor 202 connected to the circuit board 201. The second driving assembly 80 and the first driving assembly 40 are electronically connected to the circuit board 201.

Referring to FIG. 7, an embodiment of an electronic device 300 is provided. The electronic device 300 includes the camera module 200. The electronic device 300 can be a cell phone, a smart watch, an IPAD, or any other devices with optical imaging functions.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A zoom lens module, comprising:
a first lens unit;
a second lens unit;
a third lens unit;
a first driving assembly;
a second driving assembly; and
a housing;
wherein the zoom lens module defines an optical axis, the first lens unit, the second lens unit, and the third lens unit are arranged inside the housing along the optical axis, the first driving assembly is configured to drive the second lens unit to move relative to the first lens unit, the second driving assembly is configured to drive the third lens unit to move relative to the second lens unit, the first driving assembly comprises a first magnet and a second magnet, the first magnet is fixed inside the housing, the second magnet is connected to the second lens unit, the first magnet is configured to move towards the second magnet under a magnetic attraction force between the first magnet and the second magnet, the first magnet is further configured to move away from the second magnet under a magnetic repelling force between the first magnet and the second magnet.

2. The zoom lens of claim 1, wherein the first driving assembly further comprises a third magnet, the first magnet is disposed between the first magnet and the third magnet, the third magnet is configured to move towards the first magnet under a magnetic attraction force between the first magnet and the third magnet, the third magnet is configured to move away from the first magnet under a magnetic repelling force between the first magnet and the third magnet.

3. The zoom lens of claim 2, wherein the first magnet is a permeant magnet or an electromagnet, the second magnet is an electromagnet or a permeant magnet, and the third magnet is an electromagnet or a permanent magnet.

4. The zoom lens module of claim 1, wherein the second lens unit comprises a lens portion and a guide portion, the guide portion comprises a first end surface, a second end surface, and a connecting surface, the first end surface is spaced from the second end along the optical axis, the connecting surface is connected between the first end surface and the second end surface, the first magnet is disposed on the connecting surface, and the second magnet is spaced from the connecting surface.

5. The zoom lens module of claim 4, wherein the guide portion defines a through hole that penetrates the first end surface and the second end surface, the zoom lens module further comprises a guide rod, the guide rod movably goes through the through hole, two ends of the guide rod are fixed inside the housing.

6. The zoom lens module of claim 1, wherein the second driving assembly is a voice coil motor.

7. The zoom lens module of claim 1, wherein the second driving assembly is disposed on a side of the third lens unit away from the second lens unit.

8. The zoom lens module of claim 1, further comprising an optical reflector, wherein the optical reflector is disposed on a side of the first lens unit away from the second lens unit, the optical reflector is configured to change a direction of light passing through the first lens unit.

9. The zoom lens module of claim 8, wherein the optical reflector is a prism, the prism comprises a first optical surface, a second optical surface, and a third optical surface, the first optical surface, the second optical surface, and the third optical surface are connected together to form a triangular structure, the second optical surface faces the first lens unit.

10. The zoom lens module of claim 9, wherein an included angle defined between the third optical surface and the first optical surface is 45 degrees, and an included angle defined between the third optical surface and the second optical surface is 45 degrees.

11. A camera module comprising:
a circuit board;
a sensor connected to the circuit board; and
a zoom lens module comprises
a first lens unit;
a second lens unit;
a third lens unit;
a first driving assembly;
a second driving assembly; and
a housing;
wherein the zoom lens module defines an optical axis, the first lens unit, the second lens unit, and the third lens unit are arranged inside the housing along the optical axis, the first driving assembly is configured to drive the second lens unit to move relative to the first lens unit, the second driving assembly is configured to drive the third lens unit to move relative to the second lens unit, the first driving assembly comprises a first magnet and a second magnet, the first magnet is fixed inside the housing, the second magnet is connected to the second lens unit, the first magnet is configured to move towards the second magnet under a magnetic attraction force between the first magnet and the second magnet, the first magnet is further configured to move away from the second magnet under a magnetic repelling force between the first magnet and the second magnet.

12. The camera module of claim 10, wherein the first driving assembly further comprises a third magnet, the first magnet is disposed between the first magnet and the third magnet, the third magnet is configured to move towards the first magnet under a magnetic attraction force between the first magnet and the third magnet, the third magnet is configured to move away from the first magnet under a magnetic repelling force between the first magnet and the third magnet.

13. The camera module of claim 12, wherein the first magnet is a permeant magnet or an electromagnet, the second magnet is an electromagnet or a permeant magnet, and the third magnet is an electromagnet or a permanent magnet.

14. The camera module of claim 11, wherein the second lens unit comprises a lens portion and a guide portion, the guide portion comprises a first end surface, a second end surface, and a connecting surface, the first end surface is spaced from the second end along the optical axis, the connecting surface is connected between the first end surface and the second end surface, the first magnet is disposed on the connecting surface, and the second magnet is spaced from the connecting surface.

15. The camera module of claim 14, wherein the guide portion defines a through hole that penetrates the first end surface and the second end surface, the zoom lens module further comprises a guide rod, the guide rod movably goes through the through hole, two ends of the guide rod are fixed inside the housing.

16. The camera module of claim 11, wherein the second driving assembly is a voice coil motor.

17. The camera module of claim 10, wherein the second driving assembly is disposed on a side of the third lens unit faces away from the second lens unit.

18. The camera module of claim 11, further comprising an optical reflector, wherein the optical reflector is disposed on a side of the first lens unit away from the second lens unit, the optical reflector is configured to change a direction of light passing through the first lens unit.

19. The camera module of claim 18, wherein the optical reflector is a prism, the prism comprises a first optical surface, a second optical surface, and a third optical surface, the first optical surface, the second optical surface, and the third optical surface are connected together to form a triangular structure, the second optical surface faces the first lens unit.

20. An electronic device comprising a camera module, the camera module comprising:
a circuit board;
a sensor connected to the circuit board; and
a zoom lens module comprises
a first lens unit;
a second lens unit;
a third lens unit;
a first driving assembly;
a second driving assembly; and
a housing;
wherein the zoom lens module defines an optical axis, the first lens unit, the second lens unit, and the third lens unit are arranged inside the housing along the optical axis, the first driving assembly is configured to drive the second lens unit to move relative to the first lens unit, the second driving assembly is configured to drive the third lens unit to move relative to the second lens unit, the first driving assembly comprises a first magnet and a second magnet, the first magnet is fixed inside the housing, the second magnet is connected to the second lens unit, the first magnet is configured to move towards the second magnet under a magnetic attraction force between the first magnet and the second magnet, the first magnet is further configured to move away from the second magnet under a magnetic repelling force between the first magnet and the second magnet.
